(19) United States
(12) Patent Application Publication
(10) Pub. No.: US 2010/0184452 A1
(43) Pub. Date: Jul. 22, 2010

(54) POSITION TRACKING SYSTEM AND METHOD FOR PORTABLE TERMINAL

(76) Inventor: Yong-Mook Choi, Seoul (KR)

Correspondence Address: KED & ASSOCIATES, LLP, P.O. Box 221200, Chantilly, VA, 20153-1200, US

(21) Appl. No.: 12/427,287

(22) Filed: Apr. 21, 2009

(30) Foreign Application Priority Data
Jan. 22, 2009 (KR) 10-2009-0005684

(51) Int. Cl. H04W 4/02

(52) U.S. Cl. 455/456.3; 455/456.1

(57) ABSTRACT

Disclosed is a position tracking system and method for a portable terminal. If a portable terminal is connected to a computer via wired/wireless communications, the portable terminal transmits a certain software program and identification information to the computer so as to silent-install the certain software program on the computer. Upon the completion of the installation of the software program, the computer transmits the identification information of the portable terminal and the position information of the computer to the server, and the server checks whether or not the portable terminal is the lost terminal, and if the portable terminal is determined to be the lost terminal, notifies the position information to the user having lost the portable terminal.

### CROSS-REFERENCE TO a RELATED APPLICATION

Pursuant to 35 U.S.C. §119(a), this application claims the benefit of earlier filing date and right of priority to Korean Application No. 10-2009-0005684, filed on Jan. 22, 2009, the contents of which is incorporated by reference herein in its entirety.

### FIELD OF THE INVENTION

The present invention relates to a position tracking system and method for a portable terminal which identifies a location of a portable terminal through position tracking of an external device connected to the portable terminal.

### BACKGROUND OF THE INVENTION

In general, a portable terminal, such as a personal computer, a notebook computer, a mobile terminal, and the like, is configured to perform a variety of functions. Examples of such functions may include data/voice communications, capturing images or videos via a camera, recording audio, reproducing music files via a speaker system, displaying images or videos, and the like. Some terminals have been equipped with additional functionality which supports game playing, while other terminals have been implemented as an integrated multimedia player. More recently, portable terminals have been equipped with a function of receiving broadcasts or multicast signals, thereby enabling a user to watch videos or television programs.

In general, portable terminals may be classified into a mobile terminal and a stationary terminal according to its portability. The mobile terminal may be divided into a handheld terminal and a vehicle mounted terminal depending on whether it may directly be carried by a user.

Efforts are ongoing to support and increase the functionality of portable terminals. Such efforts include software and hardware improvements, as well as changes and improvements in the structural components which form the portable terminal.

In addition, efforts are ongoing to enable a user to rapidly and accurately recognize a location of a portable terminal when the portable terminal is lost or stolen.

### SUMMARY OF THE INVENTION

Therefore, an object of the present invention is to provide a position tracking system and method for a portable terminal which extracts position information of an external device, when a portable terminal is connected to the external device, by silent-installing a position extraction software program within the portable terminal on the external device.

Another object of the present invention is to provide a position tracking system and method for a portable terminal which transmits, to a server in a network, position information of an external device connected to the portable terminal and product information of the portable terminal so as to track a position of the portable terminal.

Another object of the present invention is to provide a position tracking system and method for a portable terminal which identifies a location of a lost portable terminal through position tracking of the portable terminal and notifies the identified location to a user.

To achieve these and other advantages and in accordance with the purpose of the present invention, as embodied and broadly described herein, there is provided a position tracking method for a portable terminal, including: connecting, by a portable terminal, to a computer via a wired or wireless communication; transmitting, by the portable terminal, a certain software program and identification information to the computer; silent-installing, by the computer, the certain software program; and transmitting, by the computer, the identification information of the portable terminal and the position information of the computer to the server if the software program installation is completed.

There is provided a position tracking system for a portable terminal, including: a portable terminal configured to store a certain software program; a computer configured to receive and silent-install the certain software program when being connected to the portable terminal; and a server configured to receive, from the computer, identification information of the portable terminal and position information of the computer, and if the portable terminal is determined to be the lost terminal, to notify the position information to a user having lost the portable terminal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view showing a position tracking system for a portable terminal according to one exemplary embodiment of the present invention;

FIG. 2 is a block diagram of the portable terminal according to one exemplary embodiment of the present invention;

FIG. 3 is a block diagram of a computer according to one exemplary embodiment of the present invention;

FIG. 4 is an exemplary view of a product registration screen of the portable terminal according to one exemplary embodiment of the present invention;

FIG. 5 is an exemplary view of a position tracking service application screen for the portable terminal according to one exemplary embodiment of the present invention;

FIG. 6 is an exemplary view of a position tracking function setup screen of the portable terminal according to one exemplary embodiment of the present invention;

FIG. 7 is an exemplary view of a report screen of a lost/stolen portable terminal according to one exemplary embodiment of the present invention; and

FIG. 8 is a flowchart showing a position tracking method for the portable terminal according to one exemplary embodiment of the present invention.

### DETAILED DESCRIPTION OF THE INVENTION

Description will be given in detail of the portable terminal according to the present invention, examples of which are illustrated in the accompanying drawing. For reference, suffixes “module” and “portion” of components used in the following description are given or used for facilitating the preparation of this specification, and it is not meant to have any specific meanings or functions. Therefore, the “module” and “portion” may be used together.

The portable terminal according to one exemplary embodiment of the present invention may include terminals, such as a digital camera, a mobile phone, a smart phone, Personal Digital Assistants (PDA), Portable Multimedia Player (PMP), navigations and the like.

The portable terminal in the present invention is a terminal which performs a product registration to a position tracking system and a position tracking service application in advance. The position tracking system manages product information and state information of a registered portable terminal, as well as position information thereof. The product information includes information, such as a product number, a product name, a model name, a date of purchase, and the like. The state information includes information regarding whether or not the portable terminal is lost, whether the position tracking function is activated or deactivated, and the like.

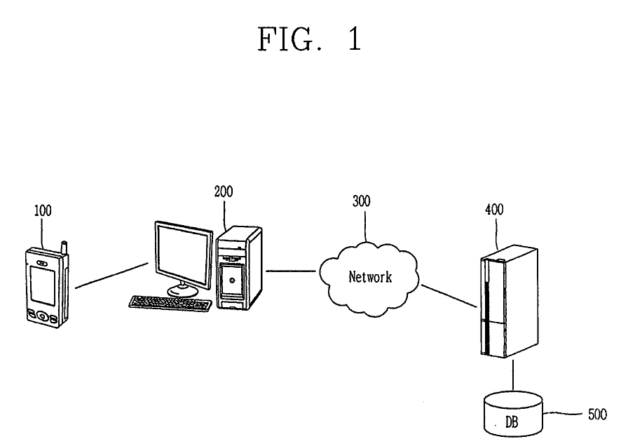

FIG. 1 is a schematic view showing a position tracking system for a portable terminal according to one exemplary embodiment of the present invention.

Referring to FIG. 1, the position tracking system for a portable terminal (hereinafter, referred to as “system”) may include a portable terminal 100, a computer 200, and a position tracking server 400.

The portable terminal 100 is connected to the certain computer 200, and stores a position extraction software program therein. The portable terminal 100 transmits the position extraction software program and the terminal-related information to the computer 200 when being connected to the computer 200. The terminal-related information refers to unique information to identify the portable terminal, and includes a product number, a serial number, or the like. The position extraction software program refers to a client program existing in a firmware of the portable terminal 100, and is silent-installed on the computer 200 when the portable terminal 100 is connected to the computer 200. The firmware is a link program for supporting a data communication between the portable terminal 100 and the computer 200.

The computer 200 is connected to the portable terminal 100 via wired/wireless interface, and is connected to the position tracking server 400 through a network 300. For instance, the computer 200 may perform a wired communication with the portable terminal 100 via Universal Serial Bus (USB) cables, Universal Asynchronous Receiver Transmitter (UART) cables, or the like. The computer 200 may perform a data communication with the portable terminal 100 via a wireless communication, such as Infrared Data Association (IrDA), BLUETOOTH, and the like.

In addition, if the portable terminal 100 is connected to the computer 200, the computer 200 receives and installs the position extraction software program transmitted from the portable terminal 100, and extracts position (location) information of the computer 200 through the installed program so as to transmit the same to the position tracking server 400. Here, the position information may use any one of an Internet Protocol (IP) address and a Media Access Control (MAC) address. That is, the position information uses unique information capable of identifying the computer 200 in the network.

Then, the computer 200 transmits the extracted position information together with the unique information of the portable terminal 100.

In the present invention, the computer 200 may be implemented as a terminal (e.g., a notebook computer, an Ultra Mobile Personal Computer (UMPC), and the like) which is capable of being connected to the potable terminal 100 and connected to the position tracking server 400 via the network 300.

The position tracking server 400 manages the portable terminals 100 to which the user has already finished product registration and/or applied for the position tracking service, and collects position information of each portable terminal so as to recognize (identify) positions of the terminals. That is, the position tracking server 400 tracks the position of the terminal joined to the position tracking service. Such position tracking server 400 includes a Database (DB) 500. The DB 500 stores registration information and position information of the portable terminal 100 which is registered to the position tracking server 400.

In addition, the position tracking server 400 may include a web server (not shown) which provides various services to the user. Examples of such services include the product registration and use authentication of the purchased portable terminal 100, the position tracking service application, verification of the terminal's position, and the like.

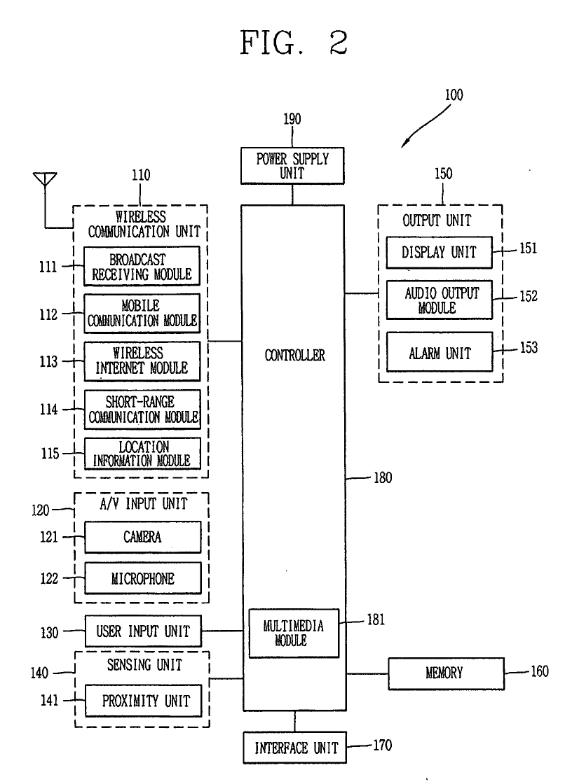

FIG. 2 is a block diagram of the portable terminal according to one exemplary embodiment of the present invention.

Referring to FIG. 2, the portable terminal 100 may include a wireless communication unit 110, an AV (Audio/Video) input unit 120, a user input unit 130, a sensing unit 140, an output unit 150, a memory 160, an interface 170, a controller 180, and a power supply 190, and the like. FIG. 2 shows the portable terminal having various components, but it is to be understood that implementing all of the illustrated components is not a requirement. A greater or fewer number of components may alternatively be implemented.

Hereinafter, the components of the portable terminal will be described in more detail.

The wireless communication unit 110 typically includes one or more components allowing radio (wireless) communication between the portable terminal 100 and a wireless communication system or a network within which the portable terminal is located. For instance, the wireless communication unit 110 may include a broadcast receiver module 111, a mobile communication module 112, a wireless internet module 113, a short-range communication module 114, a position-location module 115, and the like.

The broadcast receiver module 111 receives a broadcast signal and/or broadcast associated information from an external broadcast managing server via a broadcast channel. The broadcast channel may include a satellite channel and a terrestrial channel. The broadcast managing server may refer to a server that generates and transmits a broadcast signal and/or broadcast associated information or a server that receives a previously generated broadcast signal and/or broadcast associated information and transmits the same to a terminal. Examples of the broadcast associated information may include information regarding a broadcast channel, a broadcast program, a broadcast service provider, and the like. The broadcast signal may be implemented as a TV broadcast signal, a radio broadcast signal, and a data broadcast signal, among others. If desired, the broadcast signal may further include a broadcast signal combined with a TV or radio broadcast signal.

The broadcast associated information may be provided also via a mobile communication network and, in this case, the broadcast associated information may be received by the mobile communication module 112.

The broadcast associated information may exist in various forms. For example, it may exist in the form of an Electronic Program Guide (EPG) of Digital Multimedia Broadcasting (DMB), an Electronic Service Guide (ESG) of Digital Video Broadcast-Handheld (DVB-H), and the like.

The broadcast receiver module 111 may be configured to receive broadcast signals using various types of broadcast systems. In particular, the broadcast receiver module 111 may receive a digital broadcast signal using a digital broadcast system, such as Digital Multimedia Broadcasting-Terrestrial (DMB-T), Digital Multimedia Broadcasting-Satellite (DMB-S), Digital Video Broadcast-Handheld (DVB-H), the data broadcasting system known as media forward link only (MediaFLO®), Integrated Services Digital Broadcast-Terrestrial (ISDB-T), and the like. The broadcast receiver module 111 is configured to be suitable for every broadcast system that provides a broadcast signal as well as the above-mentioned digital broadcast systems.

A broadcast signal and/or broadcast-associated information received via the broadcast receiver module 111 may be stored in the memory 160.

The mobile communication module 112 transmits/receives radio signals to/from at least one of a base station, an external terminal and a server in a mobile communication network. Such radio signals may include a voice call signal, a video call signal or various types of data according to text/multimedia message transmission/reception.

The wireless internet module 113 supports Internet access for the portable terminal. This module 113 may be internally or externally coupled to the terminal. Examples of such wireless internet technologies may include Wireless LAN (WLAN) (Wi-Fi), Wireless broadband (Wibro), World Interoperability for Microwave Access (Wimax), High Speed Downlink Packet Access (HSDPA), and the like.

The short-range communication module 114 refers to a module for supporting short range communications. Some examples of short-range communication technology include Bluetoot™, Radio Frequency IDentification (RFID), Infrared Data Association (IrDA), Ultra-WideBand (UWB), ZigBee™, and the like.

The position-location module 115 identifies or otherwise obtains the location of the portable terminal. If desired, this module may be implemented using Global Positioning System (GPS) components. For instance, the GPS module 115 may accurately calculate a 3-D current location of the terminal based on latitude, longitude and height by trigonometric measurement which measures accurate time and distance from three or more satellites and uses 3 different distance values. The GPS module 115 may use a method which obtains time and distance information from 3 satellites and corrects an error with one satellite. In addition, the GPS module 115 may obtain speed information by continuously calculating the current position in real-time.

The AN input unit 120 is configured to input an audio or video signal. The A/V input unit 120 may include a camera 121 and a microphone 122. The camera 121 processes image frames of still pictures or videos obtained by an image capture device in an image capturing mode or a video call mode. The processed image frames may be displayed on the display 151.

The image frames processed by the camera 121 may be stored in the memory 160 or transmitted via the wireless communication unit 110. Two or more cameras 121 may be provided according to the configuration of the portable terminal.

The microphone 122 may receive an external analog audio signal (audible sound) in a phone call mode, a recording mode, a voice recognition mode, or the like, and process it into digital data. The processed audio (voice) data may be converted for output into a format transmittable to a mobile communication base station via the mobile communication module 112 in case of the phone call mode. The microphone 122 may include various types of noise canceling (or suppression) algorithms to cancel (or suppress) noise generated in the course of receiving and transmitting audio signals.

The user input unit 130 may generate key input data inputted by a user to control various operations of the portable terminal. The user input unit 130 may include a keypad, a dome switch, a touch pad (e.g., a touch sensitive member that detects changes in resistance, pressure, capacitance, etc.), a jog wheel, a jog switch, and the like. In particular, when a touch pad is overlaid on the display 151 in a layered manner, it may be referred to as a touch screen.

The sensing unit 140 provides status measurements of various aspects of the portable terminal 100. For instance, the sensing unit 140 may detect an open/close state of the portable terminal 100, relative positioning of components (e.g., a display and keypad) of the portable terminal 100, a change of position of the portable terminal 100 or a component of the portable terminal 100, a presence or absence of user contact with the portable terminal 100, orientation or acceleration/deceleration of the portable terminal 100, and the like. As an example, when the portable terminal 100 is a slide-type portable terminal, the sensing unit 140 may sense whether a sliding portion of the portable terminal 100 is open or closed. Other examples include the sensing unit 140 sensing the presence or absence of power provided by the power supply 190, the presence or absence of a coupling or other connection between the interface 170 and an external device, and the like. Meanwhile, the sensing unit 140 may include a proximity sensor 141, which will be later described with a touch screen.

The interface 170 serves as an interface with at least one external device connected with the portable terminal 100. For example, the external devices may include wired/wireless headset ports, external power charger ports, wired/wireless data ports, memory card ports, ports for connecting a device having a identification module, audio input/output (I/O) ports, video I/O ports, earphone ports, among others.

Here, the identification module is implemented as a chip to store various types of information to identify an authorization right for the portable terminal 100, and may include a User Identity Module (UIM), a Subscriber Identity Module (SIM), a Universal Subscriber Identity Module (USIM), and so on. A device having the identification module (hereinafter, referred to as ‘identification device’) may be implemented as a smart card type. Accordingly, the identification device may be connected to the portable terminal 100 through a port. The interface 170 may be used to receive inputs (e.g., data, information, power, etc.) from an external device and transfer the received inputs to one or more elements within the portable terminal 100 or may be used to transfer data from the portable terminal to an external device.

When the portable terminal 100 is connected to an external cradle, the interface 170 may serve as a passage through which power from the external cradle is supplied to the portable terminal 100, or a passage through which each kind of command signals input from the external cradle by a user are transmitted to the portable terminal 100. Said each kind of command signals input from the external cradle, or said power may operate as signals for recognizing that the portable terminal 100 has been precisely mounted to the external cradle.

The interface 170 serves as a connector for connecting the portable terminal to an external device by using USB cables, UART cables, and the like. For instance, a connecter at one side of the USB cable is connected to the interface 170, while a connector at another side thereof is connected to an external device, thus to connect the portable terminal 100 to the external device.

The output unit 150 is configured to provide outputs in a visual, audible, and/or tactile manner (e.g., audio signal, video signal, alarm signal, etc.). The output unit 150 may include the display 151, an audio output module 152, an alarm output module 153, and the like.

The display 151 may output information processed in the portable terminal 100. For example, when the portable terminal 100 is in the phone call mode, the display 151 may display a User Interface (UI) or a Graphic User Interface (GUI) associated with a call or other communication on a screen display thereof. When the portable terminal 100 is in the video call mode or the image capturing mode, the display 151 may display a captured and/or received image, a UI, a GUI, and the like on its screen display.

Meanwhile, when the display 151 and the touch pad are overlaid in a layered manner to form a touch screen, the display 151 may function as both an input device and an output device. The display 151 may include at least one of a Liquid Crystal Display (LCD) panel, a Thin Film Transistor-LCD (TFT-LCD) panel, an Organic Light Emitting Diode (OLED) display, a flexible display screen, a three-dimensional (3D) display screen, or the like. Among others, some displays may be configured to be transparent so as to be seen from outside therethrough. This may be referred to as a transparent display, such as a Transparent Organic Light Emitting Diode (TOLED), or the like. The portable terminal 100 may include two or more displays (or other display means) 151 according to its desired implementation. For instance, the portable terminal 100 may include an external display unit (not shown) and an internal display unit (not shown). The touch screen may be configured to sense a location and area of a touch input as well as a pressure of a touch input.

Meanwhile, a proximity sensor 141 may be arranged at an inner region of the portable terminal covered by the touch screen, or near the touch screen. The proximity sensor 141 refers to a sensor to sense presence or absence of an object approaching to a surface to be sensed, or an object disposed near a surface to be sensed, by using an electric field or infrared rays without a mechanical contact. The proximity sensor 141 has a longer lifespan and a more enhanced utilization degree than a contact sensor.

Examples of such proximity sensor 141 may include a transmissive type photoelectric sensor, a direct reflective type photoelectric sensor, a mirror reflective type photoelectric sensor, a high-frequency oscillation type proximity sensor, a capacitance type proximity sensor, a magnetic type proximity sensor, an infrared rays proximity sensor, and so on.

Among these, an operation principle of the high-frequency oscillation type proximity sensor is as follows: in a state that a high frequency full wave is oscillated in the oscillatory circuit, if an object to be sensed approaches a sensor surface, an oscillation amplitude of the oscillatory circuit is reduced or stopped. Such change is converted into an electrical signal, thus to detect the presence or absence of the object to be sensed. Accordingly, although any material, other than a metallic material, is positioned between the high-frequency oscillation type proximity sensor and the object to be sensed, a proximity switch may detect the object to be sensed without being interfered by the object.

Even though the proximity sensor 141 is not mounted, if the touch screen is a static pressure type, it may be configured to detect the proximity of the pointer by a change of an electric field due to the proximity of the pointer.

Therefore, even though the pointer is positioned to be proximate onto the touch screen without actually contacting the touch screen, a position of the pointer and a distance between the pointer and the touch screen may be detected. Hereinafter, for convenience in explanation, a status that the pointer is positioned to be proximate onto the touch screen without contact will be referred to as ‘proximity touch’, whereas a status that the pointer substantially comes in contact with the touch screen will be referred to as ‘contact touch’. The pointer in a status of ‘proximity touch’ is positioned so as to be vertical with respect to the touch screen.

The proximity sensor 141 senses proximity touch, and proximity touch patterns (e.g., distance, direction, speed, time, position, moving status, and the like). Information relating to the sensed proximity touch, and the sensed proximity touch patterns may be output onto the touch screen.

The audio output module 152 may output audio data received from the wireless communication unit 110 or stored in the memory 160 in a call signal reception mode, a call mode, a recording mode, a voice recognition mode, a broadcast reception mode, and the like. Also, the audio output module 152 may provide audible outputs related to a particular function (e.g., a call signal reception sound, a message reception sound, or the like) performed by the portable terminal 100. The audio output module 152 may include a speaker, a buzzer, or the like.

The alarm 153 may provide outputs to inform about the occurrence of an event of the portable terminal 100. Typical events may include a call signal reception, a message reception, a key signal input, a touch input, and the like. In addition to audio or video outputs, the alarm 153 may provide outputs in a different manner to inform about the occurrence of an event. For example, the alarm 153 may provide outputs in the form of vibrations (or other tactile means). When a call signal, a message, or some other incoming communication is received, the alarm 153 may provide tactile outputs (i.e., vibrations) to inform the user. By providing tactile outputs, the user can recognize the occurrence of various events. Outputs informing about the occurrence of an event may be also provided via the display 151 or the audio output module 152.

The memory 160 may store software programs or the like used for the processing and controlling performed by the controller 180, or may temporarily store inputted/outputted data (e.g., a phonebook, messages, still images, video, or the like.). In addition, the memory 160 may store data regarding various types of vibrations and sounds outputted when the touch screen is touched.

The memory 160 may store a link program to enable a data communication with an external device connected to the portable terminal 100. The link program includes a position extraction software program for extracting position information of the external device connected to the portable terminal 100. The position extraction software program refers to a client program which is silent-installed on the external device when the portable terminal 100 is connected to the external device.

The memory 160 may include at least one type of storage medium including a flash memory type, a hard disk type, a multimedia card micro type, a card-type memory (e.g., SD or XD memory, or the like), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. Also, the portable terminal 100 may cooperate with a web storage device on the internet that remotely performs the storage function of the memory 160.

The portable terminal 100 also includes the controller 180 that typically controls the overall operations of the portable terminal 100. For instance, the controller 180 performs the control and processing associated with voice calls, data communications, instant message communications, video calls, and the like. The controller 180 may also include a multimedia module 181 for providing multimedia reproduction functions. The multimedia module 181 may be configured as part of the controller 180, or may be implemented as a separate component.

The controller 180 may perform a pattern recognition processing in which a handwriting input and a picture-drawing input performed on the touch screen are respectively recognized as a text and an image.

The controller 180 may activate or deactivate a position tracking function according to a control command inputted from the user input unit 130. When the position tracking function is activated, if any connection between the portable terminal 100 and the external device is sensed, the controller 180 transmits the link program and/or the position extraction software program stored in the memory 160 to the external device. Here, the controller 180 checks whether or not the program is installed on the external device, and only if the program is checked not to be installed, transmits such programs to the external device for an installation. In addition, the controller 180 executes the position extraction software program stored in the memory 160 if the portable terminal 100 is connected to the external device. Once the program is executed, the controller 180 extracts position information of the connected external device.

The power supply 190 provides power used by the various components for the portable device under the control of the controller 180. The provided power may be internal power, external power, or combinations thereof.

Various functionalities described herein may be implemented in a computer-readable medium using, for example, computer software, hardware, or any combination thereof.

For a hardware implementation, the functionalities described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units designed to perform the functions described herein. In some cases, such functionalities may be implemented by the controller 180.

For a software implementation, the functionalities such as operation procedures or functions may be implemented together with separate software modules that allow performing of at least one function or operation. Software codes can be implemented by a software application written in any suitable programming language. The software codes may be stored in the memory 160 and executed by the controller 180.

FIG. 3 is a block diagram of a computer according to one exemplary embodiment of the present invention. Here, the structure of the computer 200 is similar to that of the above-described portable terminal 100, thus to be briefly described. In addition, the computer 200 has been described for the better understanding, but a terminal enabling data communication with the portable terminal 100 via wired/wireless communications and capable of being connected to an external device through a network (internet network) may be implemented.

The computer 200 in the present invention may include a communication unit 210, an input unit 220, an interface 230, a video output unit 240, an audio processing unit 250, a memory 260, a power unit 270, a Central Processing Unit (CPU) 280, and the like.

The communication unit 210 enables the wired/wireless communication with the portable terminal 100 or the connection to another computer on a network or a server. The communication unit 210 may include a broadcast receiver module (not shown) for receiving broadcast signals, similar to the wireless communication unit 110 of the portable terminal 100, a mobile communication module (not shown) for transmitting and receiving various types of data via a mobile communication network, an internet module (not shown) for an Internet access, a short-range communication module (not shown) for supporting short-range communications, and the like.

The internet module may include a wired communication module for supporting a connection to an IP-based wired communication network operating over TCP/IP and/or UDP/IP, and a wireless communication module for supporting a wireless communication network connection such as WLAN and Wi-Fi.

The short-range communication module performs short-range communications with the portable terminal 100 or an external terminal. The short-range communication module may include Radio Frequency Identification (RFID), Infrared Data Association (IrDA), BLUETOOTH, and the like. The computer 200 may perform data communications with the portable terminal 100 through the short-range communication module.

The input unit 220 receives a signal generated by a manipulation of the input device such as a keyboard and a mouse, and generates a control command and data corresponding to the signal.

The interface 230 serves as an interface (link) for connecting the computer 200 and an external terminal. The interface 230 may include USB ports, serial ports, and the like. For instance, one side of the USB cable is connected to the interface 230 of the computer 200, and another side thereof is connected to the interface 170 of the portable terminal 100, thus to connect the portable terminal 100 and the computer 200. Here, the external terminal may include the portable terminal 100, MP3 players, PMP, notebook computers, personal computers, and the like.

The video output unit 240 outputs states and results according to overall operations of the computer 200 to a display device. The display device may include an LCD, OLED, CRT, TOLED, and the like. As described above, the display device may be implemented as a touch screen to function as an input device as well as an output device.

The audio processing unit 250 may provide an audio signal inputted through the input device such as a microphone to the CPU 280 or output an audio signal generated when the CPU 280 of the computer 200 performs a particular function to the output device such as a speaker.

The memory 260 may store a variety of programs to perform a control of overall operations of the computer 200 as well as various types of data generated by operations of the computer 200. In addition, the memory 260 may store terminal-related information received from the portable terminal 100, the link program, the position extraction software program, and the like.

The power unit 270 receives external or internal (battery) power and supplies power required for the operations of the respective elements.

The CPU 280 performs the control of overall operations and applications of the computer 200. The CPU 280 senses a connection to an external terminal via the interface 230. That is, if the portable terminal 100 is connected to the computer 200, the CPU 280 receives the position extraction software program provided by the potable terminal 100 and silent-installs the program without being recognized by the user. More specifically, the CPU 280 dose not display an installation screen of the position extraction software program on the display screen. In addition, upon completion of the installation of the position extraction software program, the CPU 280 extracts the position information of the computer and transmits the same to the position tracking server 400.

In addition, if a notification that the portable terminal 100 connected to the computer 200 is determined to be a lost or stolen terminal is given by the position tracking server 400, the CPU 280 restricts particular functions (operations) of the portable terminal 100. For instance, the CPU 280 transmits a command (e.g., stop using the terminal, a locked mode) to the portable terminal 100 so as to restrict the operation of the portable terminal.

Hereinafter, descriptions of position tracking of the portable terminal according to one exemplary embodiment of the present invention will be given.

The following two steps should be performed for the position tracking of the portable terminal 100.

First, a product registration should be performed. After a user purchases the portable terminal 100, the user registers the portable terminal 100 to the position tracking server 400 according to a certain procedure.

Second, an application for a position tracking service for the portable terminal 100 should be performed. The user may apply for the position tracking service for at least one or more of the portable terminals 100 during or after the product registration. Here, the user makes a connection to the position tracking server 400 for an application for the position tracking service, and activates a position tracking function of the terminal through a menu manipulation of the portable terminal 100.

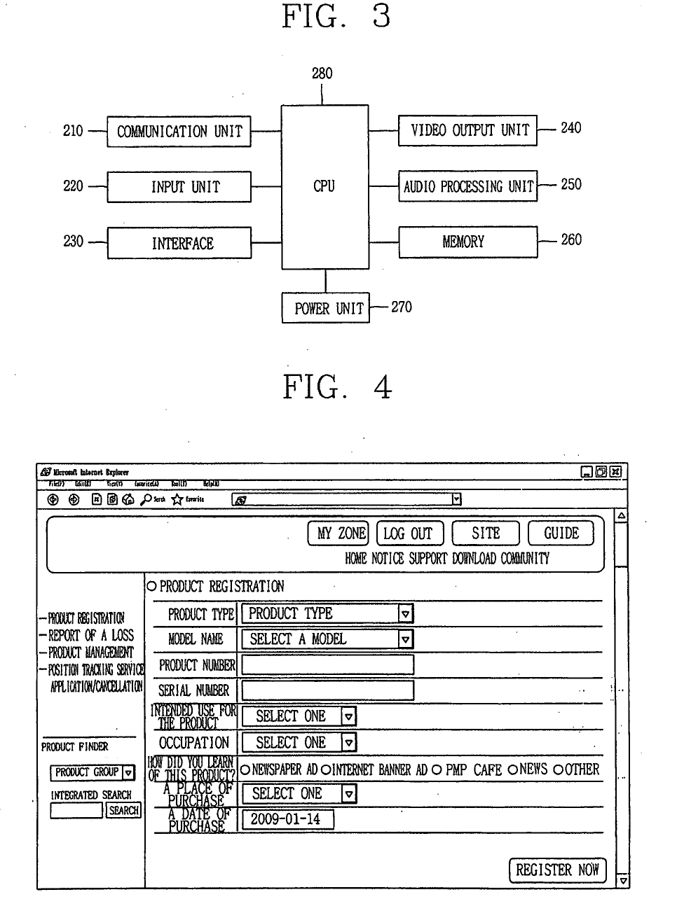

FIG. 4 is an exemplary view of a product registration screen of the portable terminal according to one exemplary embodiment of the present invention. For the better understanding in explanations, this exemplary embodiment has described a case of using the computer 200 to connect to the position tracking server 400 for the product registration.

First, the user makes a connection to the position tracking server 400 via the communication unit 210 of the computer 200 after purchasing the portable terminal 100. For instance, the user makes a connection to a manufacturer's website by using the computer 200 so as to register the purchased portable terminal. This exemplary embodiment has described a case of Internet connection via the communication unit 210 of the computer 200. However, the user may also be connected to the position tracking server 400 via the wireless internet module 113 of the portable terminal 100.

If an item “product registration” is selected from a web page provided by the website, the website presents a product registration screen as shown in FIG. 4. The user may input information related to the purchased terminal to the product registration screen through an input device (e.g., a keyboard, a mouse or the like). For instance, the user may input terminal-associated information, such as a product type, a model name, a product number, a serial number, and the like as well as additional information, such as a date of purchase, a place of purchase (store name), purchasing motive (how did you learn of this product?), intended use for the product, and the like.

The computer 200 transmits data inputted by the user's manipulation of the input unit 220 to the website. That is, the CPU 280 of the computer 200 performs a control of the communication unit 210 so as to transmit the data inputted by the user to the position tracking server 400.

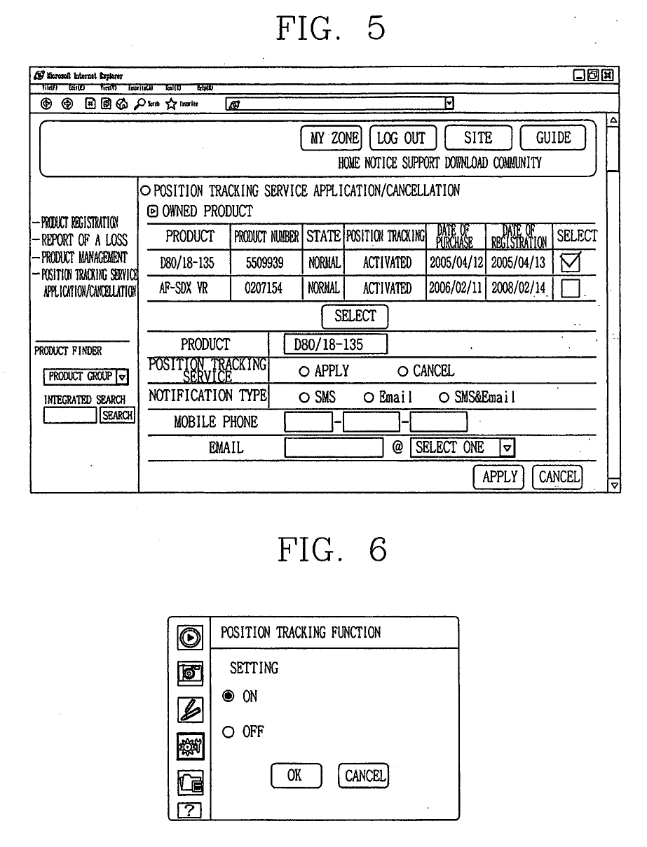

FIG. 5 is an exemplary view of a position tracking service application screen for the portable terminal according to one exemplary embodiment of the present invention. This exemplary embodiment describes a case of applying the position tracking service for at least one or more products among the registered products.

After the product registration for the purchased terminal has been completed, if the user selects a menu for applying the position tracking service on the web page, the position tracking server 400 provides a screen for applying the position tracking service as shown in FIG. 5.

The position tracking service application screen may include a list of the portable terminals previously registered and a service application form. The user selects at least one of the list of the pre-registered terminals (product list owned by the user), and inputs information related to the position tracking service. For instance, the user may select whether to apply for the service, and then select a notification type for position information of the portable terminal in case the terminal is missing or stolen. Here, the notification type may be implemented as a text message and/or an email.

Here, the computer 200 is configured to transmit, to the position tracking server 400, information related to the position tracking service application that is inputted by the user. The position tracking server 400 receives the input information transmitted via the network 300 and stores the information in the DB 500.

FIG. 6 is an exemplary view of a position tracking function setup screen of the portable terminal according to one exemplary embodiment of the present invention. This exemplary embodiment describes an activation of the position tracking function in the portable terminal.

Once the product registration of the portable terminal 100 and the position tracking service application have been completed, the position tracking function for the portable terminal 100 may be set. First, if a menu is selected through the user input unit 130 of the portable terminal 100, menu items are displayed on the display screen. If the position tracking function is selected among the menu items, the controller 180 of the portable terminal 100 may display a setting screen on the display 151, as shown in FIG. 6, to allow the user to set the position tracking function.

On the setting screen displayed on the display 151, the controller 180 is configured to set the position tracking function as ‘activated’ according to the user input, and then stores the set information in the memory 160.

If the setting is completed, the controller 180 activates the position tracking function. Then, if the connection between the portable terminal 100 and the external device is detected (sensed), the controller 180 is configured to silent-install the position extraction software program which is pre-stored in the memory 160 to the external device. That is, during the installation of the position extraction software program, the external device does not output any information related to the installation of the position extraction software program through the output unit (e.g., the display, the speaker, and the like).

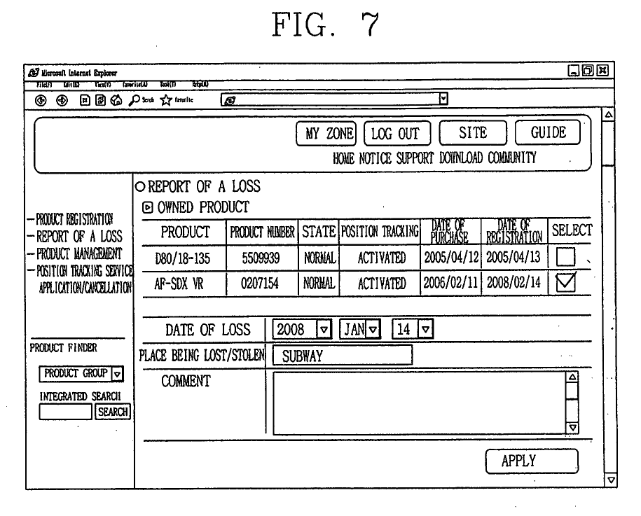

FIG. 7 is an exemplary view of a report screen of a lost or stolen portable terminal according to one exemplary embodiment of the present invention.

If the portable terminal 100 is lost or stolen, the user connects to the website where he has applied for the position tracking service so as to report the loss of the portable terminal. First, the user connects to the position tracking server 400 by using another computer or portable terminal, and makes a report of the lost (or stolen) portable terminal. Here, the terminal used by the user for reporting the lost terminal is configured to transmit data inputted by the user to the position tracking server 400, and receive a web page provided by the position tracking server 400 so as to display the web page on the display screen.

If a menu “lost or stolen product report” is selected on the main web page provided by the position tracking server 400, the position tracking server 400 transmits the lost or stolen product report screen to the terminal used for reporting the lost terminal. Then, the terminal displays the received report screen on the display screen.

As shown in FIG. 7, the lost product report screen displays a list of the products registered by the user and a lost product report form. First, the user selects the lost (or stolen) terminal among the terminals registered to the position tracking server 400 on the lost product report screen. After selecting the lost terminal 100, the user inputs information, such as a date of loss, a location being lost/stolen, comments, and the like. Here, the notification type for position information of the lost (or stolen) portable terminal may be set or modified, e.g., changing the pre-set phone number, adding another notification type, or the like.

If the lost product report is completed, the position tracking server 400 is configured to add the reported terminal to the list of the lost (or stolen) terminals. If the position information of the reported terminal is received from an external entity (source), the position tracking server 400 notifies the received position information to the user based on the pre-set notification type. That is, the position tracking server 400 notifies the location of the lost portable terminal to the user through a text message and/or an email.

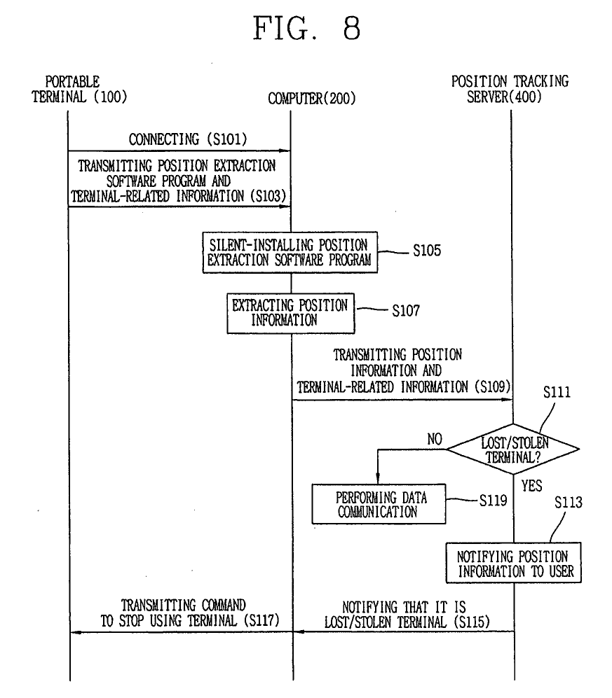

FIG. 8 is a flowchart showing a position tracking method for the portable terminal according to one exemplary embodiment of the present invention. The portable terminal 100 in this exemplary embodiment is a terminal which has already completed the product registration and the position tracking service application.

First, the lost (or stolen) portable terminal 100 is connected to a certain computer 200 by a third party (S101). Here, the portable terminal 100 is connected to the interface 230 of the computer 200 through a communication cable. Such interface 230 may include a connection unit, such as USB ports, legacy ports, serial ports, parallel ports, and the like. In this exemplary embodiment, the portable terminal 100 is connected to the computer 200, however, it may be connected to a terminal (e.g., a notebook computer, UMPC, or the like) capable of being connected to an external internet network.

When the portable terminal 100 and the computer 200 are connected, the controller 180 of the portable terminal 100 transmits to the computer 200 the position extraction software program and the terminal-related information stored in the memory 160 (S103). The position extraction software program is a client program included in a link program enabling the data communication between the portable terminal 100 and the computer 200. The terminal-related information refers to unique information to identify the portable terminal 100, and includes a serial number, a product number, an Electronic Serial Number (ESN) and the like.

After the position extraction software program is transmitted to the computer 200, the CPU 280 of the computer 200 performs a silent-installation of the received position extraction software program (S105). Here, the CPU 280 is configured not to display (output) any information related to the program installation on the display screen or through the audio processing unit 250.

Once the silent-installation of the position extraction software program is completed, the CPU 280 executes the position extraction software program and thereby to extract position information of the computer 200 (S107). The position information may be an IP address, a MAC address or the like.

If the position information of the computer 200 is extracted, the CPU 280 of the computer 200 transmits, to the position tracking server 400, the extracted position information and the terminal-related information transmitted from the portable terminal 100 (S109). The CPU 280 is connected to the position tracking server 400 via the communication unit 210, and transmits the extracted position information and the portable terminal-related information to the position tracking server 400.

Upon receiving the position information of the computer 200 and the portable terminal-related information from the computer 200, the position tracking server 400 uses the portable terminal-related information to check (determine) whether or not the portable terminal 100 is the lost (or stolen) terminal (S111).

If the portable terminal 100 is determined to be the lost terminal, the position tracking server 400 notifies the position information of the computer 200 to the user (S113). The position tracking server 400 transmits the received position information to the user via a text message or an email.

The position tracking server 400 notifies to the computer 200 that the portable terminal 100 connected to the computer 200 is the lost terminal (S115). Then, the computer 200 may transmit ‘a command to stop using the terminal’ to the potable terminal 100. Upon receiving the command, the portable terminal 100 activates a “locked” function or blocks certain functions to be used.

In addition, the CPU 280 of the computer 200 may output a warning message on the display through the video output unit 240 or output a warning sound through the audio processing unit 250.

In the above step S111, if the portable terminal 100 is determined not to be the lost terminal, the computer 200 performs a data communication with the portable terminal 100. For instance, the CPU 280 of the computer 200, having received a message notifying that the portable terminal 100 is not the lost or stolen terminal, requests a link program from the portable terminal 100 connected to the interface 230. Upon receiving the link program from the portable terminal 100, the CPU 280 installs the link program and performs the data communication with the portable terminal 100 through the installed program.

In the above example, if the portable terminal 100 is connected to the external terminal capable of being connected to the position tracking server via the external network 300, the position extraction software program stored in the portable terminal 100 is silent-installed at the external terminal, thus to extract the position information of the external terminal. However, the present invention is not meant to be limiting, but may also be configured as follows: if the external terminal and the portable terminal 100 are connected, the portable terminal 100 executes the position extraction software program within the terminal, and requests position information from the external terminal. Upon receiving the position information from the external terminal, the portable terminal 100 may transmit, to the position tracking server, information related to the portable terminal 100 together with the received information.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

With such described configuration, the portable terminal according to at least one exemplary embodiment of the present invention may silent-install, if it is connected to an external device (e.g., a personal computer), the position extraction software program stored in the portable terminal to the connected external device, thus to extract position information of the external device.

The present invention may collect position information of an external device to which the portable terminal is connected, and track (recognize) the position of the lost or stolen portable terminal.

If the position of the lost or stolen portable terminal is tracked, the present invention may also transmit position information of the portable terminal to the user.

If the position of the lost or stolen portable terminal is tracked, the present invention may block (restrict) certain operations of the portable terminal.

Further, according to one exemplary embodiment, a medium for recording a program can be implemented as a code that can be read by a computer. The medium that can be read by a computer includes all types of recording devices for storing data such as a ROM, a RAM, a CD-ROM, a magnetic tape, a floppy disk, and an optical data storing device. The medium can be also implemented as a carrier wave (e.g., a data transmission through the Internet). The computer may include the controller 180 of the portable terminal.

What is claimed is:

1. A position tracking method for a portable terminal, comprising:
connecting, by a portable terminal, to a computer via a wired or wireless communication;
transmitting, by the portable terminal, a certain software program and identification information to the computer;
silent-installing, by the computer, the certain software program; and
transmitting, by the computer, the identification information of the portable terminal and the position information of the computer to the server if the software program installation is completed.

2. The position tracking method of claim 1, wherein the certain software program is a client program silent-installed on the computer.

3. The position tracking method of claim 2, wherein the client program is included in a link program enabling a data communication between the portable terminal and the computer.

4. The position tracking method of claim 1, wherein the certain software program is configured to extract position information of a terminal on which the certain software program is installed.

5. The position tracking method of claim 1, wherein the position information includes at least one or more of an IP address and a MAC address.

6. The position tracking method of claim 1, further comprising:
checking, by the server, whether or not the portable terminal is a lost terminal by using the identification information; and
notifying, by the server, the position information to a user having lost the portable terminal if the portable terminal is determined to be the lost terminal.

7. The position tracking method of claim 6, wherein the step of notifying the position information includes transmitting the position information to the user having lost the portable terminal via a text message and/or an email.

8. The position tracking method of claim 6, wherein the step of notifying the position information includes notifying to the computer that the portable terminal is the lost terminal if the portable terminal is determined to be the lost terminal.

9. The position tracking method of claim 8, further comprising:
transmitting, by the computer, to the portable terminal a command to restrict at least certain portions of operations of the portable terminal.

10. A position tracking system for a portable terminal, comprising:
a portable terminal configured to store a certain software program;
a computer configured to receive and silent-install the certain software program when being connected to the portable terminal; and
a server configured to receive, from the computer, identification information of the portable terminal and position information of the computer, and if the portable terminal is determined to be the lost terminal, to notify the position information to a user having lost the portable terminal.

11. The position tracking system of claim 10, wherein the portable terminal transmits the certain software program and the identification information of the portable terminal to the computer via a wireless communication.

12. The position tracking system of claim 11, wherein the identification information includes at least one or more of an electronic serial number (ESN), a serial number, a product number.

13. The position tracking system of claim 10, wherein the computer is connected to the server via a network.

14. The position tracking system of claim 10, wherein the computer does not display an installation screen of the certain software program.

15. The position tracking system of claim 10, wherein the server includes product information of the portable terminal, user information, and a database for storing the position information.

16. The position tracking system of claim 15, wherein the product information includes information such as a product number, a serial number, a model name, a product type, a date of purchase, a place of purchase.

17. The position tracking system of claim 10, wherein the server compares the identification information of the portable terminal with identification information of the terminal which has been reported lost or stolen so as to check whether or not the portable terminal is the lost terminal.

18. The position tracking system of claim 17, wherein if the portable terminal is determined to be the lost terminal, the portable terminal is set to “lock” by the server.

19. The position tracking system of claim 17, wherein the server compares the identification information of the portable terminal with the identification information of the terminal having reported lost or stolen so as to notify the comparison result to the computer.
